(19) United States
(12) Patent Application Publication
(10) Pub. No.: US 2022/0171518 A1
(43) Pub. Date: Jun. 2, 2022

(54) INFORMATION PROCESSING DEVICE, INFORMATION PROCESSING METHOD, AND PROGRAM

(71) Applicant: SONY GROUP CORPORATION, Tokyo (JP)

(72) Inventors: Atsushi ISHIHARA, Kanagawa (JP); Yufeng JIN, Kanagawa (JP); Osamu ITO, Tokyo (JP); Ryo YOKOYAMA, Tokyo (JP); Ikuo YAMANO, Tokyo (JP); Takeshi OGITA, Kanagawa (JP)

(73) Assignee: SONY GROUP CORPORATION, Tokyo (JP)

(21) Appl. No.: 17/432,346

(22) PCT Filed: Feb. 14, 2020
(86) PCT No.: PCT/JP2020/005905

§ 371 Date: Aug. 19, 2021

(30) Foreign Application Priority Data
Feb. 26, 2019 (JP) 2019-032930

(51) Int. Cl. G06F 3/041; G06F 3/01

(52) U.S. Cl. CPC G06F 3/04182; G06F 3/016; G06F 3/0414

(57) ABSTRACT

An information processing device includes: an acquisition unit that acquires sensing information regarding a user and first haptic information unique to a haptic presentation object; and a data processing unit that generates second haptic information from the first haptic information on the basis of the sensing information, the second haptic information being used in a case where a haptic presentation device presents a haptic stimulus to the user.

### TECHNICAL FIELD

The present disclosure relates to an information processing device, an information processing method, and a program.

### BACKGROUND ART

Various technologies for presenting a haptic stimulus such as vibration to a user have been conventionally proposed. As an example, there is a technology of presenting, to a user, a haptic stimulus based on sensing information regarding the user. For example, Patent Document 1 below discloses a technology of presenting, to a driver, a haptic stimulus determined on the basis of sensing information regarding a situation surrounding a vehicle.

### CITATION LIST

### Patent Document

Patent Document 1: Japanese Patent Application Laid-Open No. 2016-081521

### SUMMARY OF THE INVENTION

### Problems to be Solved by the Invention

The technology disclosed in Patent Document 1 is intended to notify a driver who drives a vehicle of an emergency. Therefore, it is sufficient for the driver to recognize a haptic stimulus presented to the driver as an emergency, and therefore reality thereof is not considered at all.

In view of this, the present disclosure proposes a novel and improved information processing device, information processing method, and program capable of presenting a more realistic haptic stimulus.

### Solutions to Problems

The present disclosure provides an information processing device including: an acquisition unit that acquires sensing information regarding a user and first haptic information unique to a haptic presentation object; and a data processing unit that generates second haptic information from the first haptic information on the basis of the sensing information, the second haptic information being used in a case where a haptic presentation device presents a haptic stimulus to the user.

Further, the present disclosure provides an information processing method executed by a processor, the method including: acquiring sensing information regarding a user and first haptic information unique to a haptic presentation object; and generating second haptic information from the first haptic information on the basis of the sensing information, the second haptic information being used in a case where a haptic presentation device presents a haptic stimulus to the user.

Furthermore, the present disclosure provides a program for causing a computer to function as: an acquisition unit that acquires sensing information regarding a user and first haptic information unique to a haptic presentation object; and a data processing unit that generates second haptic information from the first haptic information on the basis of the sensing information, the second haptic information being used in a case where a haptic presentation device presents a haptic stimulus to the user.

### BRIEF DESCRIPTION OF DRAWINGS

FIG. 1 illustrates an outline of processing according to an embodiment of the present disclosure.

FIG. 2 illustrates an exemplary presentation of a haptic stimulus according to the embodiment.

FIG. 3 is a block diagram illustrating a configuration example of a haptic presentation system according to the embodiment.

FIG. 4 illustrates a configuration example of haptic information according to the embodiment.

FIG. 5 illustrates a generation example of second haptic information based on a change in speed according to the embodiment.

FIG. 6 illustrates a generation example of second haptic information based on a change in speed according to the embodiment.

FIG. 7 illustrates a generation example of second haptic information based on a pressure according to the embodiment.

FIG. 8 illustrates a generation example of second haptic information based on a pressure according to the embodiment.

FIG. 9 illustrates a generation example of second haptic information based on a contact area according to the embodiment.

FIG. 10 illustrates a generation example of second haptic information based on a humidity according to the embodiment.

FIG. 11 illustrates a generation example of second haptic information based on a size of a haptic presentation unit according to the embodiment.

FIG. 12 illustrates a generation example of second haptic information based on a scale ratio according to the embodiment.

FIG. 13 illustrates a generation example of second haptic information based on a scale ratio according to the embodiment.

FIG. 14 illustrates a generation example of second haptic information based on a scale ratio according to the embodiment.

FIG. 15 illustrates an example of mapping second haptic information according to the embodiment.

FIG. 16 illustrates an example of scaling second haptic information according to the embodiment.

FIG. 17 is a flowchart showing a flow of processing performed in a case where haptic information according to the embodiment is processed without being switched.

FIG. 18 is a flowchart showing a flow of processing performed in a case where haptic information according to the embodiment is switched and is then processed.

FIG. 19 illustrates a specific exemplary presentation of a haptic stimulus in a first specific example according to the embodiment.

FIG. 20 illustrates a specific exemplary presentation of a haptic stimulus in a second specific example according to the embodiment.

FIG. 21 illustrates an exemplary presentation of a haptic stimulus in a first modification example according to the embodiment.

FIG. 22 illustrates an exemplary presentation of a haptic stimulus in a second modification example according to the embodiment.

FIG. 23 illustrates an exemplary presentation of a haptic stimulus in a third modification example according to the embodiment.

FIG. 24 is a block diagram illustrating a hardware configuration example of an information processing device according to an embodiment of the present disclosure.

### MODE FOR CARRYING OUT THE INVENTION

Hereinafter, preferred embodiments of the present disclosure will be described in detail with reference to the accompanying drawings. Note that, in this specification and the drawings, components having substantially the same functional configurations will be represented as the same reference signs, and repeated description thereof will be omitted.

Note that description will be provided in the following order.

1. Overview

2. Configuration Example

3. Processing Examples

4. Specific Examples

5. Modification Examples

6. Hardware Configuration

7. Conclusion

### 1. OVERVIEW

A technology according to an embodiment of the present disclosure relates to an information processing device that presents a haptic stimulus based on sensing information to a user. The information processing device according to the present embodiment generates second haptic information from first haptic information unique to a haptic presentation object on the basis of sensing information regarding a user, the second haptic information being used in a case where a haptic presentation device presents a haptic stimulus to the user.

The sensing information regarding the user can include various types of information. For example, the sensing information includes contact information indicating a contact state between the user and the haptic presentation device. Examples of the contact information encompass a moving speed (acceleration) of a part of the user in contact with the haptic presentation device (hereinafter, also referred to as “contact part”), a pressure applied from the contact part to a contact presentation device, and an area where the contact part and the haptic presentation device are in contact with each other. Note that the contact information is not limited to such examples. With such a configuration, the information processing device can generate the second haptic information from the first haptic information on the basis of the contact information.

Further, the sensing information includes non-contact information indicating a non-contact state between the user and the haptic presentation device. Examples of the non-contact information encompass a body temperature of the user, a humidity of a body surface of the user, and a distance from the haptic presentation device to the contact part. Note that the non-contact information is not limited to such examples. With such a configuration, the information processing device can generate the second haptic information from the first haptic information on the basis of the non-contact information.

Further, the sensing information includes environmental information regarding a surrounding environment of the user. Examples of the environmental information encompass a temperature and humidity of a space where the user exists. Note that the environmental information is not limited to such examples. With such a configuration, the information processing device can generate the second haptic information from the first haptic information on the basis of the environmental information.

The haptic presentation object is a target object based on which a haptic stimulus is presented to the user via the haptic presentation device. Information regarding the haptic presentation object can be managed in association with, for example, an image of the haptic presentation object.

The first haptic information includes information regarding a haptic stimulus that is transmitted to the user when the user actually touches the haptic presentation object. For example, the first haptic information includes information indicating a quantified intensity of a haptic stimulus (hereinafter, also referred to as “haptic stimulus value”).

The haptic stimulus value is information unique to the haptic presentation object. The haptic stimulus value can be set for each predetermined region. For example, in a case where the haptic presentation object is shown as an image, the haptic stimulus value may be set for each pixel of the image. Further, one haptic stimulus value may be set for a plurality of pixels. Furthermore, the image showing the haptic presentation object may be divided into a plurality of regions of any size, and the haptic stimulus value may be set for each region. Hereinafter, a region where the haptic stimulus value is set will also be referred to as “haptic stimulus value region”. Further, in the following description, “information density” indicates an amount of haptic stimulus values that are set per unit area of the image.

The second haptic information is information generated from the first haptic information on the basis of the sensing information. For example, the second haptic information is generated by changing (hereinafter, also referred to as “processing”) the haptic stimulus value included in the first haptic information on the basis of the sensing information. Hereinafter, processing of generating the second haptic information will also be referred to as “generation processing”.

After the second haptic information is generated, the information processing device causes the haptic presentation device to present, to the user, a haptic stimulus based on the generated second haptic information. For example, the information processing device maps the haptic stimulus value included in the second haptic information onto a region where the haptic presentation device can present a haptic sensation (hereinafter, also referred to as “haptic presentation region”). Then, the information processing device causes the haptic presentation device to present, to the user, a haptic stimulus of an intensity indicated by the haptic stimulus value mapped onto a position in the haptic presentation region touched by the user.

A haptic sensation that the user feels when touching an object in a real space typically depends on the way the user touches the object and characteristics unique to the object such as a material and hardness of the object. In this regard, the information processing device according to the present embodiment generates the second haptic information on the basis of the sensing information corresponding to the way the user touches the object and the first haptic information corresponding to the characteristics unique to the object, thereby presenting a realistic haptic stimulus to the user.

(Outline of Processing)

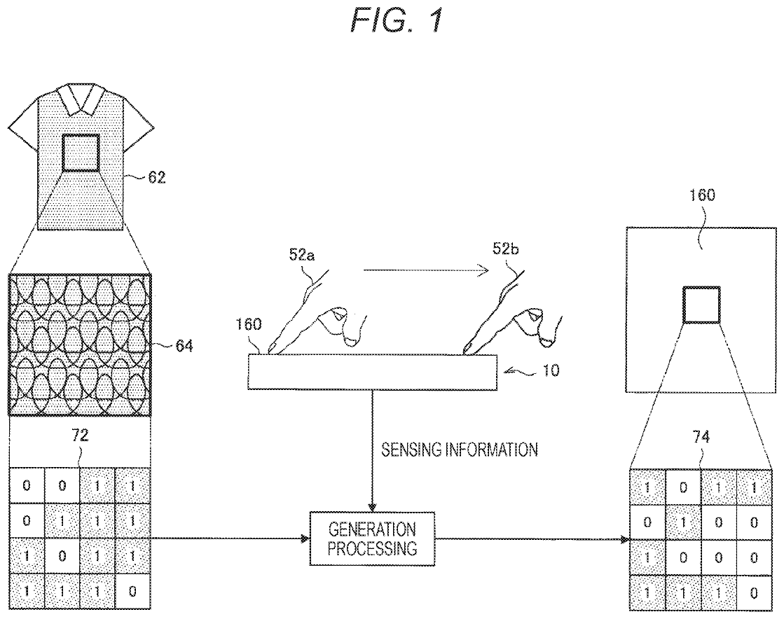

Herein, an outline of processing according to the embodiment of the present disclosure will be described with reference to FIG. 1. FIG. 1 illustrates the outline of the processing according to the embodiment of the present disclosure. Hereinafter, there will be described an example where, when the user touches a haptic presentation unit 160 of a haptic presentation device 10, a haptic stimulus equivalent to that obtained when the user actually touches an actual object of a haptic presentation object 62 is presented to the user.

The haptic presentation object 62 in the example of FIG. 1 is a shirt. A surface of the actual shirt has, for example, a fiber structure as illustrated in a region 64. First haptic information 72 indicates haptic stimulus values corresponding to a haptic sensation that the user feels when actually touching the region 64 of the actual shirt. The first haptic information 72 in FIG. 1 has four regions in height and four regions in width, i.e., sixteen regions in total having the same size, and a haptic stimulus value is set in each region. In the example of FIG. 1, 0 or 1 is set as the haptic stimulus value as an example. Note that the haptic stimulus value is not limited to such examples, and a value other than 0 or 1 may be set.

The user moves his/her hand from a position of a hand 52a to a position of a hand 52b while keeping the hand in contact with the haptic presentation unit 160. At this time, for example, an amount of change in a moving speed obtained when the user moves his/her hand is acquired as the sensing information. In a case where the sensing information is acquired, the haptic presentation device 10 performs generation processing. In the generation processing, the haptic presentation device 10 processes the first haptic information 72 on the basis of the sensing information, thereby generating second haptic information 74 that reflects a change in the way the user touches.

The generated second haptic information 74 is mapped onto the haptic presentation unit 160. Then, the haptic presentation unit 160 presents a haptic stimulus to the user on the basis of the haptic stimulus value of the second haptic information 74 mapped onto a position of the haptic presentation unit 160 touched by the user.

(Exemplary Presentation of Haptic Stimulus)

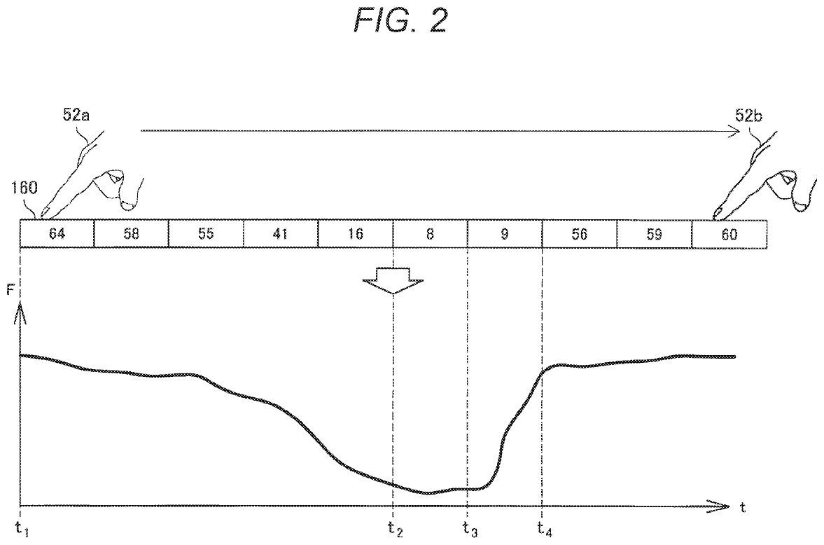

Here, an exemplary presentation of a haptic stimulus according to the embodiment of the present disclosure will be described with reference to FIG. 2. FIG. 2 illustrates an exemplary presentation of a haptic stimulus according to the embodiment of the present disclosure.

As illustrated in an upper diagram of FIG. 2, first, the user moves his/her hand in contact with the haptic presentation unit 160 from a position of the hand 52a to a position of the hand 52b. At this time, a change in speed of a contact part of the user is acquired as the sensing information. Next, the second haptic information, which is generated by processing the first haptic information on the basis of the acquired sensing information, is mapped onto the haptic presentation unit 160. Then, the haptic presentation device 10 reads a haptic stimulus value mapped onto a position of the haptic presentation unit 160 touched by the user, and converts the haptic stimulus value into a presentation signal. Then, the haptic presentation device 10 inputs the converted presentation signal to the haptic presentation unit 160, and causes the haptic presentation unit 160 to present a haptic sensation.

A graph in a lower diagram of FIG. 2 is a graph of the haptic stimulus values mapped onto the haptic presentation unit 160. A vertical axis of the graph indicates a haptic stimulus value F, and a horizontal axis thereof indicates time t. As shown in the graph, the haptic stimulus value gradually decreases from 64 to 8 from t₁ to t₂, and thus the intensity of a haptic stimulus presented to the user gradually decreases. The haptic stimulus value does not change, i.e., keeps 8 from t₂ to t₃, and thus the intensity of the haptic stimulus presented to the user hardly changes either. The haptic stimulus value presented to the user rapidly increases from 9 to 56 from t₃ to t₄, and thus the intensity of the haptic stimulus presented to the user rapidly increases. The haptic stimulus value hardly changes after t₄, and thus the intensity of the haptic stimulus presented to the user hardly changes either.

(Summary of Problems)

Herein, problems are summarized. General haptic presentation devices do not present, to the user, a haptic stimulus obtained by processing a haptic stimulus value on the basis of the sensing information. Therefore, the general haptic presentation devices do not generate the second haptic information from the first haptic information even if information indicating a change in the way the user touches is acquired as the sensing information.

The embodiment of the present disclosure has been made in view of the above point, and proposes a technology capable of presenting a more realistic haptic stimulus. Hereinafter, the present embodiment will be sequentially described in detail.

### 2. CONFIGURATION EXAMPLE

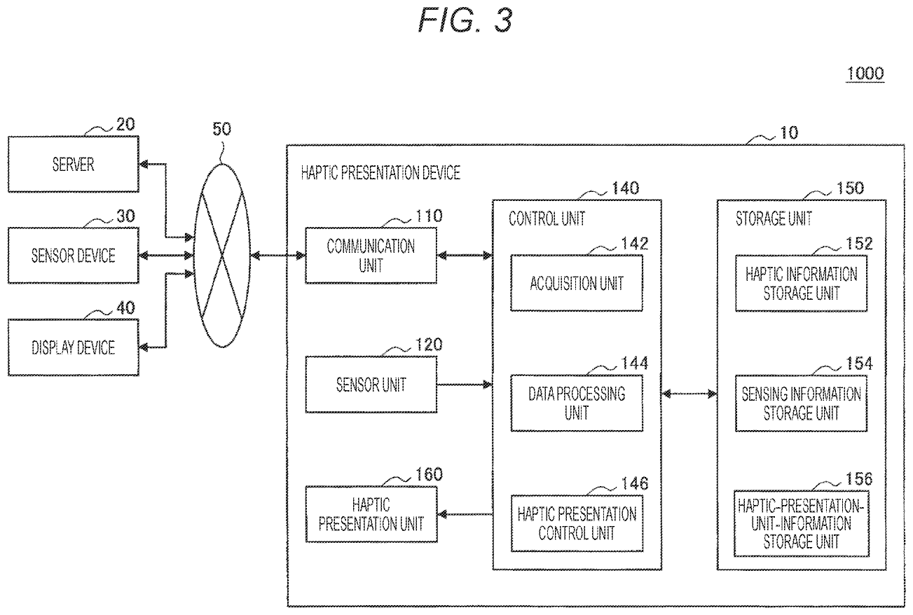

First, a configuration example of an information processing system according to the embodiment of the present disclosure will be described with reference to FIG. 3. FIG. 3 is a block diagram illustrating a configuration example of a haptic presentation system 1000 according to the embodiment of the present disclosure.

<2-1. System Configuration>

As illustrated in FIG. 2, the haptic presentation system 1000 according to the present embodiment includes the haptic presentation device 10, a server 20, a sensor device 30, a display device 40, and a network 50.

(1) Haptic Presentation Device 10

The haptic presentation device 10 is a device (information processing device) that presents a haptic stimulus to an arbitrary target. For example, the haptic presentation device 10 presents a haptic stimulus to a part of the user in contact with the haptic presentation device.

The haptic presentation device 10 is connected to the server 20 via the network 50, and can transmit and receive information to and from the server 20. Further, the haptic presentation device 10 is connected to the sensor device 30 via the network 50, and can transmit and receive information to and from the sensor device 30. Furthermore, the haptic presentation device 10 is connected to the display device 40 via the network 50, and can cause the display device 40 to display an image of the haptic presentation object.

In the haptic presentation device 10, haptic presentation processing is performed by the information processing device according to the present embodiment. For example, the information processing device is provided in the haptic presentation device 10, and performs the haptic presentation processing of presenting a haptic stimulus to the haptic presentation unit of the haptic presentation device 10. Hereinafter, an example where the information processing device is provided in the haptic presentation device 10 will be described. However, a device in which the information processing device is provided is not limited to the haptic presentation device 10, and may be any device. For example, the information processing device may be provided in the server 20 to control the haptic presentation processing in the haptic presentation device 10 via the network 50.

(2) Server 20

The server 20 is a server device having a function of storing information regarding the haptic presentation processing of the haptic presentation device 10. For example, the server 20 may be a haptic information server that stores the first haptic information.

The server 20 is connected to the haptic presentation device 10 via the network 50, and can transmit and receive information to and from the haptic presentation device 10. For example, the server 20 transmits the first haptic information to the haptic presentation device 10 via the network 50.

(3) Sensor Device 30

The sensor device 30 has a function of sensing information used for processing in the haptic presentation device 10. For example, the sensor device 30 senses the sensing information regarding the user. After sensing, the sensor device 30 transmits the sensing information to the haptic presentation device 10 via the network 50.

The sensor device 30 can include various sensor devices. As an example, the sensor device 30 may include a camera, a thermosensor, and a humidity sensor. Note that the sensor devices included in the sensor device 30 are not limited to such examples, and any other sensor device may be included.

The camera is an imaging device that includes a lens system, a drive system, and an imaging element of an RGB camera or the like and captures an image (a still image or a moving image). For example, the camera captures a captured image showing a contact state between the user and the haptic presentation device 10. Therefore, the camera is desirably provided at a position at which the contact state between the user and the haptic presentation device 10 can be imaged. With such a configuration, the sensor device 30 can acquire the captured image showing the contact state between the user and the haptic presentation device 10 as the contact information.

The thermosensor is a device that senses a temperature. The thermosensor can sense various temperatures. For example, the thermosensor senses a temperature of a space where the user exists. Further, the thermosensor senses the body temperature of the user. Furthermore, the thermosensor senses a temperature of an object (e.g., the haptic presentation device 10) with which the user is in contact. With such a configuration, the sensor device 30 can acquire the temperature of the space where the user exists as the environmental information, the body temperature of the user as the non-contact information, and the temperature of the object in contact with the user as the contact information.

The humidity sensor is a device that senses a humidity. The humidity sensor can sense various humidities. For example, the humidity sensor senses a humidity of the space where the user exists. Further, the humidity sensor senses a humidity of the body surface of the user. Furthermore, the humidity sensor senses a humidity of a contact position between the user and an object (e.g., the haptic presentation device 10). With such a configuration, the sensor device 30 can acquire the humidity of the space where the user exists as the environmental information, the humidity of the body surface of the user as the non-contact information, and the humidity of the contact position between the user and the object as the contact information.

(4) Display Device 40

The display device 40 has a function of displaying an image regarding the haptic presentation processing of the haptic presentation device 10. For example, in a case where the haptic presentation object is an image, the display device 40 displays the image.

The display device 40 is connected to the haptic presentation device 10 via the network 50, and can transmit and receive information to and from the haptic presentation device 10. For example, the display device 40 receives an image of the haptic presentation object from the haptic presentation device 10 via the network 50 and displays the image.

The display device 40 can be achieved by various devices. For example, the display device 40 is achieved by a terminal device including a display unit, such as a personal computer (PC), a smartphone, a tablet terminal, a wearable terminal, or an agent device.

Note that the display device 40 may be achieved by a display. Examples of the display encompass a CRT display, a liquid crystal display, a plasma display, and an EL display. Further, the display device 40 may be achieved by a laser projector, an LED projector, or the like.

(5) Network 50

The network 50 has a function of connecting the haptic presentation device 10 and the server 20 and connecting the haptic presentation device 10 and the sensor device 30. The network 50 may include public networks such as the Internet, a telephone network, and a satellite communication network, various local area networks (LANs) including Ethernet (registered trademark), wide area networks (WANs), and the like. Further, the network 50 may include a dedicated network such as the Internet protocol-virtual private network (IP-VPN). Furthermore, the network 50 may include wireless communication networks such as Wi-Fi (registered trademark) and Bluetooth (registered trademark).

<2-2. Functional Configuration>

Next, a functional configuration of the haptic presentation device 10 according to the embodiment of the present disclosure will be described. As illustrated in FIG. 2, the haptic presentation device 10 according to the present embodiment includes a communication unit 110, a sensor unit 120, a control unit 140, a storage unit 150, and the haptic presentation unit 160.

(1) Communication Unit 110

The communication unit 110 has a function of communicating with an external device. For example, in communicating with the external device, the communication unit 110 outputs information received from the external device to the control unit 140. Specifically, in communicating with the server 20 via the network 50, the communication unit 110 receives the first haptic information from the server 20 and outputs the first haptic information to the control unit 140.

For example, in communicating with the external device, the communication unit 110 transmits information input from the control unit 140 to the external device. Specifically, the communication unit 110 transmits, to the server 20, information indicating the haptic presentation object serving as a target from which the first haptic information is acquired. The information is input from an acquisition unit 142 of the control unit 140 at the time of acquiring the first haptic information.

(2) Sensor Unit 120

The sensor unit 120 has a function of sensing information used for processing in the control unit 140. For example, the sensor unit 120 senses the sensing information regarding the user. After sensing, the sensor unit 120 outputs the sensing information to the control unit 140.

The sensor unit 120 can include various sensor devices. As an example, the sensor unit 120 may include a touchscreen, a pressure-sensitive sensor, an acceleration sensor, a gyro sensor, and a proximity sensor. Note that the sensor devices included in the sensor unit 120 are not limited to such examples, and any other sensor device may be included. As an example, the sensor unit 120 may include the camera, the thermosensor, and the humidity sensor described above as the sensor devices that can be included in the sensor device 30.

The touchscreen is a device that senses a contact state. For example, the touchscreen detects whether or not the touchscreen is in contact with the target. As an example, the touchscreen detects whether or not the user and the haptic presentation unit 160 are in contact with each other. Further, the touchscreen Further, the touchscreen senses a speed while the target is in contact with the touchscreen. As an example, in a case where the user touches the haptic presentation unit 160, the touchscreen senses a speed at which the user moves the contact part. With such a configuration, the sensor unit 120 can acquire, as the contact information, information indicating whether or not the user is in contact with the haptic presentation unit 160 and a moving speed of the contact part.

The pressure-sensitive sensor is a device that senses a pressure. For example, the pressure-sensitive sensor senses a pressure applied to the pressure-sensitive sensor when the pressure-sensitive sensor is brought into contact with a target. As an example, in a case where the user and the haptic presentation unit 160 are brought into contact with each other, the pressure-sensitive sensor senses a pressure applied to the contact part. Further, in a case where the pressure-sensitive sensor is brought into contact with the target, the pressure-sensitive sensor senses a contact area with the target. As an example, in a case where the user and the haptic presentation unit 160 are brought into contact with each other, the pressure-sensitive sensor senses an area of the contact part. With such a configuration, in a case where the user and the haptic presentation unit 160 are brought into contact with each other, the sensor unit 120 can acquire the pressure applied to the contact part and the area of the contact part as the contact information.

The acceleration sensor is a device that senses acceleration. For example, the acceleration sensor senses acceleration that is an amount of change in speed at which a target moves. As an example, the acceleration sensor senses the acceleration when the user moves the contact part in contact with the haptic presentation unit 160. With such a configuration, the sensor unit 120 can acquire, as the contact information, the acceleration when the user moves the contact part.

The gyro sensor is a device that senses an angular velocity. For example, the gyro sensor senses an angular velocity that is an amount of change in a posture of the target. As an example, in a case where the haptic presentation device 10 is achieved as a device held and operated by the user, the gyro sensor senses the angular velocity when the user changes a posture of the haptic presentation device 10. With such a configuration, the sensor unit 120 can acquire, as the contact information, the angular velocity when the user changes the posture of the haptic presentation device 10.

The proximity sensor is a device that detects a nearby object. The proximity sensor may be achieved by various devices. As an example, the proximity sensor may be achieved by a depth camera that senses distance information from an object ahead. With such a configuration, the sensor unit 120 can acquire, as the non-contact information, a distance from a contact part of the user who is assumed to be in contact with the haptic presentation unit 160.

(3) Control Unit 140

The control unit 140 is an information processing device having a function of controlling the entire operation of the haptic presentation device 10. In order to achieve the function, the control unit 140 includes the acquisition unit 142, a data processing unit 144, and a haptic presentation control unit 146 as illustrated in FIG. 2.

(3-1. Acquisition Unit 142)

The acquisition unit 142 has a function of acquiring the sensing information. For example, the acquisition unit 142 acquires the sensing information regarding the user and the first haptic information. At the time of acquiring the sensing information, the acquisition unit 142 can acquire the sensing information from a plurality of acquisition sources. For example, the acquisition unit 142 acquires information sensed by the sensor unit 120 as the sensing information from the sensor unit 120. Further, the acquisition unit 142 may acquire information sensed by the sensor device 30 as the sensing information from the sensor device 30 via the communication unit 110. Note that the acquisition unit 142 may acquire the sensing information from either one or both of the sensor unit 120 and the sensor device 30.

After acquiring the sensing information, the acquisition unit 142 outputs the acquired sensing information to the data processing unit 144. With such a configuration, the acquisition unit 142 can output the sensing information acquired from both the sensor unit 120 and the sensor device 30 to the data processing unit 144. Note that the acquisition unit 142 may output the acquired sensing information to the storage unit 150 to cause the storage unit 150 to store the acquired sensing information.

At the time of acquiring the first haptic information, the acquisition unit 142 acquires the first haptic information from the server 20 (haptic information server) via the network 50. After acquiring the first haptic information, the acquisition unit 142 outputs the acquired first haptic information to the data processing unit 144. Note that the acquisition unit 142 may output the acquired first haptic information to the storage unit 150 to cause the storage unit 150 to store the acquired first haptic information.

Note that, in a case where the first haptic information is held in the storage unit 150, the acquisition unit 142 may acquire the first haptic information from the storage unit 150. With such a configuration, the acquisition unit 142 can improve processing efficiency in the control unit 140, as compared with a case where the first haptic information is acquired from the server 20 via the network 50.

(3-2. Data Processing Unit 144)

The data processing unit 144 has a function of performing generation processing of the second haptic information. For example, the data processing unit 144 generates the second haptic information from the first haptic information on the basis of the sensing information, the second haptic information being used in a case where the haptic presentation unit 160 presents a haptic stimulus to the user. Specifically, the data processing unit 144 generates the second haptic information by changing a haptic stimulus value included in the first haptic information input from the acquisition unit 142 on the basis of the sensing information also input from the acquisition unit 142. Then, the data processing unit 144 maps the generated second haptic information onto the haptic presentation unit 160. Hereinafter, the processing performed by the data processing unit 144 will be sequentially described in detail.

(3-2-1. Configuration of Haptic Information)

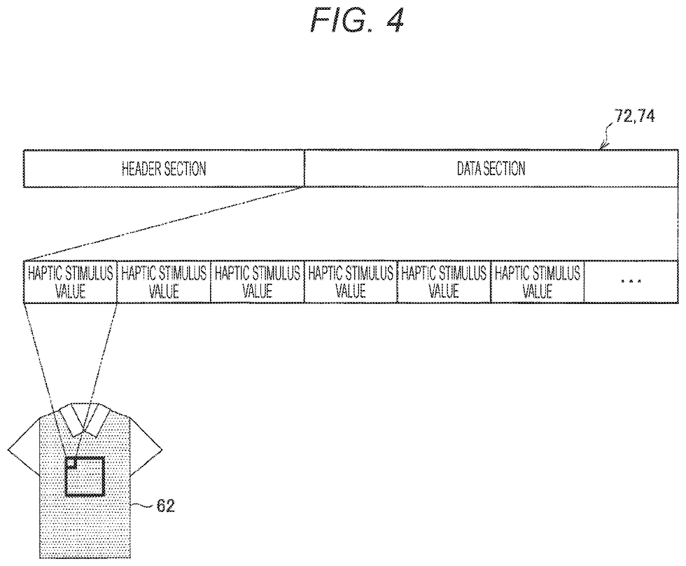

First, a configuration example of haptic information according to the embodiment of the present disclosure will be described with reference to FIG. 4. FIG. 4 illustrates the configuration example of the haptic information according to the embodiment of the present disclosure. Note that the configuration of the haptic information described below is common to the first haptic information and the second haptic information. As illustrated in FIG. 4, the haptic information includes a header section and a data section.

The header section can store information regarding the haptic information. The information regarding the haptic information is, for example, a data size of the haptic information, information regarding a predetermined region, globally applied information, or the like. In a case where the haptic presentation object is an image 66 as illustrated in FIG. 4, the predetermined region herein is a region of each pixel. Note that the predetermined region may be a haptic stimulus value region. Further, the information regarding the predetermined region is, for example, a size of the predetermined region or the like.

The data section can store information for each predetermined region. As illustrated in FIG. 4, the data section has a part in which the information for each predetermined region is stored, and the number of parts is at least the number of predetermined regions. The information for each predetermined region is, for example, the haptic stimulus value.

(3-2-2. Generation of Second Haptic Information)

(Generation Examples Based on Sensing Information)

For example, the data processing unit 144 generates the second haptic information by processing the first haptic information on the basis of the sensing information.

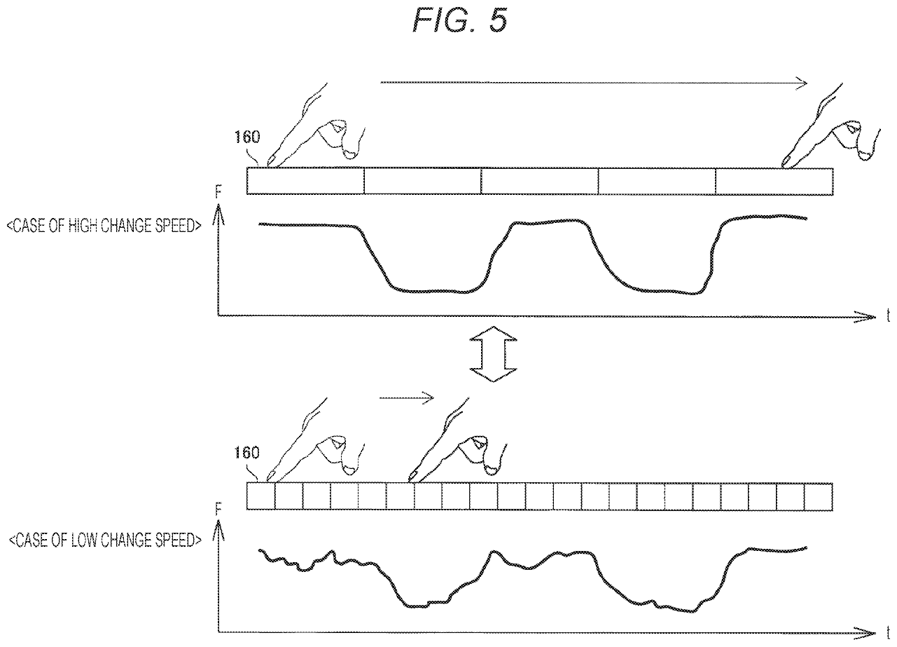

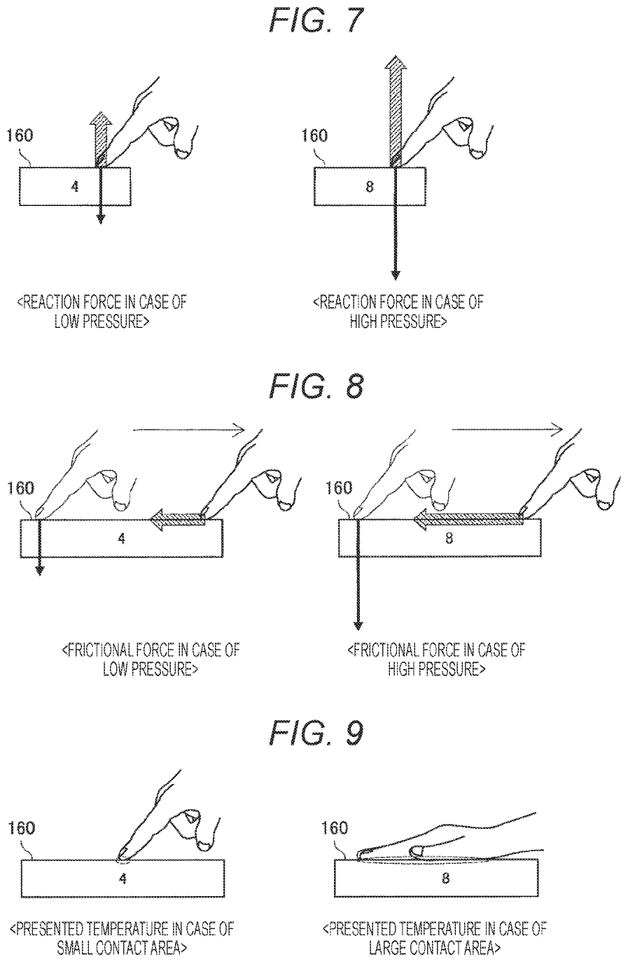

As an example, the data processing unit 144 generates the second haptic information by processing the first haptic information on the basis of the contact information. Herein, generation of the second haptic information based on the contact information will be described with reference to FIGS. 5 to 16. Note that, in examples of FIGS. 7 to 10, the haptic stimulus value set as the first haptic information from which the second haptic information is generated is assumed to be 6.

Generation Examples Based on Speed

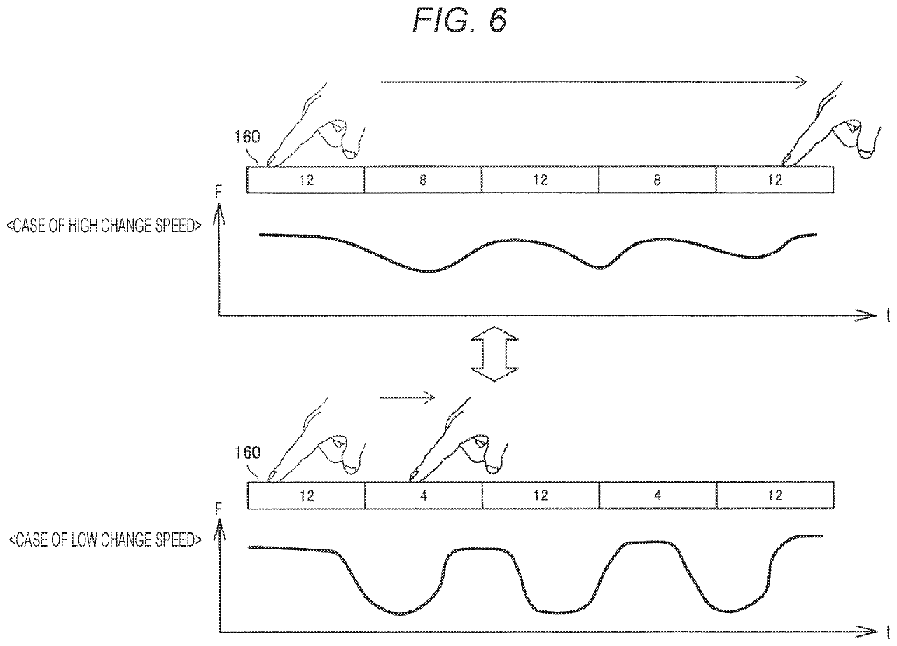

For example, the data processing unit 144 generates the second haptic information on the basis of a change speed at a contact position between the haptic presentation unit 160 and the user. Hereinafter, a specific description will be given with reference to FIGS. 5 and 6. FIGS. 5 and 6 illustrate generation examples of the second haptic information based on a change in speed according to the embodiment of the present disclosure.

For example, the data processing unit 144 generates the second haptic information by processing the first haptic information in accordance with the change speed at the contact position. Specifically, the data processing unit 144 generates the second haptic information in which an amount of change in haptic stimulus per unit distance is smaller as the change speed at the contact position is higher, and generates the second haptic information in which the amount of change in haptic stimulus per unit distance is larger as the change speed at the contact position is lower.

FIG. 5 illustrates an example where the amount of change in haptic stimulus per unit distance is changed by switching the information density in accordance with a change in speed on the basis of the first haptic information having different information densities prepared in advance. In a case where the change speed is high, as illustrated in an upper diagram of FIG. 5, the data processing unit 144 switches to the first haptic information having a low information density, thereby generating the second haptic information in which the amount of change in haptic stimulus per unit distance is small. Meanwhile, in a case where the change speed is low, as illustrated in a lower diagram of FIG. 5, the data processing unit 144 switches to the first haptic information having a high information density, thereby generating the second haptic information in which the amount of change in haptic stimulus per short distance is large.

FIG. 6 illustrates an example where the haptic stimulus value is processed by filtering the first haptic information so as to change the amount of change in haptic stimulus per unit distance. In a case where the change speed is high, as illustrated in an upper diagram of FIG. 6, the data processing unit 144 reduces a difference between the haptic stimulus values of adjacent haptic stimulus value regions, thereby generating the second haptic information in which the amount of change in haptic stimulus per unit distance is small. Meanwhile, in a case where the change speed is low, as illustrated in a lower diagram of FIG. 6, the data processing unit 144 increases the difference between the haptic stimulus values of the adjacent haptic stimulus value regions, thereby generating the second haptic information in which the amount of change in haptic stimulus per unit distance is large.

Generation Examples Based on Pressure

Further, the data processing unit 144 generates the second haptic information on the basis of a pressure between the haptic presentation unit 160 and the user. Hereinafter, a specific description will be given with reference to FIGS. 7 and 8. FIGS. 7 and 8 illustrate generation examples of the second haptic information based on the pressure according to the embodiment of the present disclosure.

FIG. 7 illustrates an example of presenting, to the user, reaction force corresponding to an intensity of the pressure (contact pressure) that is applied to the haptic presentation unit 160 when the user comes into contact with the haptic presentation unit 160. In a case were the pressure is low, as illustrated in a left diagram of FIG. 7, the data processing unit 144 processes the haptic stimulus value of the first haptic information from 6 to 4, thereby generating the second haptic information so as to present weak reaction force to the user. Meanwhile, in a case where the pressure is high, as illustrated in a right diagram of FIG. 7, the data processing unit 144 processes the haptic stimulus value of the first haptic information from 6 to 8, thereby generating the second haptic information so as to present strong reaction force to the user.

FIG. 8 illustrates an example of presenting, to the user, frictional force corresponding to the intensity of the pressure (contact pressure) that is applied to the haptic presentation unit 160 when the user comes in contact with the haptic presentation unit 160. In a case were the pressure is low, as illustrated in a left diagram of FIG. 8, the data processing unit 144 processes the haptic stimulus value of the first haptic information from 6 to 4, thereby generating the second haptic information so as to present weak frictional force to the user. Meanwhile, in a case where the pressure is high, as illustrated in a right diagram of FIG. 8, the data processing unit 144 processes the haptic stimulus value of the first haptic information from 6 to 8, thereby generating the second haptic information so as to present strong frictional force to the user.

Generation Example Based on Contact Area

Further, the data processing unit 144 generates the second haptic information on the basis of the contact area between the haptic presentation unit 160 and the user. Hereinafter, a specific description will be given with reference to FIG. 9. FIG. 9 illustrates a generation example of the second haptic information based on the contact area according to the embodiment of the present disclosure.

FIG. 9 illustrates an example of presenting, to the user, a temperature corresponding to the size of the contact area where the user is in contact with the haptic presentation unit 160. In a case where the contact area is small, as illustrated in a left diagram of FIG. 9, the data processing unit 144 processes the haptic stimulus value of the first haptic information from 6 to 4, thereby generating the second haptic information so as to present a low temperature to the user. Meanwhile, in a case where the contact area is large, as illustrated in a right diagram of FIG. 9, the data processing unit 144 processes the haptic stimulus value of the first haptic information from 6 to 8, thereby generating the second haptic information so as to present a high temperature to the user.

Generation Example Based on Environmental Information

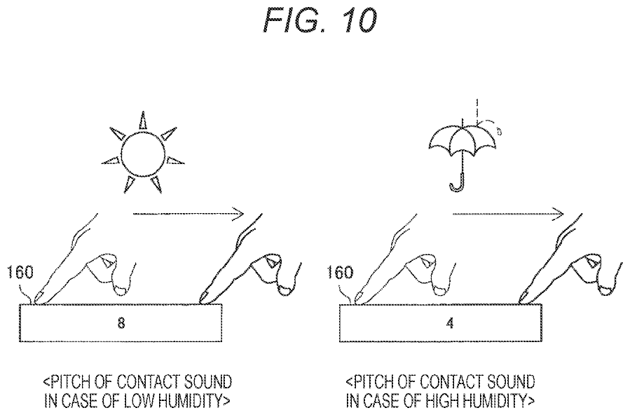

Further, the data processing unit 144 may generate the second haptic information further on the basis of the environmental information. Hereinafter, a specific description will be given with reference to FIG. 10. FIG. 10 illustrates a generation example of the second haptic information based on a humidity according to the embodiment of the present disclosure.

Generation Example Based on Humidity

FIG. 10 illustrates an example of presenting, to the user, a contact sound having a frequency corresponding to the humidity when the user comes into contact with the haptic presentation unit 160. In a case where the humidity is low, as illustrated in a left diagram of FIG. 10, the data processing unit 144 processes the haptic stimulus value of the first haptic information from 6 to 8, thereby generating the second haptic information so that a large number of high-frequency components are contained in the contact sound to be presented to the user. Meanwhile, in a case where the humidity is high, as illustrated in a right diagram of FIG. 10, the data processing unit 144 processes the haptic stimulus value of the first haptic information from 6 to 4, thereby generating the second haptic information so that a small number of high-frequency components are contained in the contact sound to be presented to the user.

(Generation Example Based on Size of Haptic Presentation Unit 160)

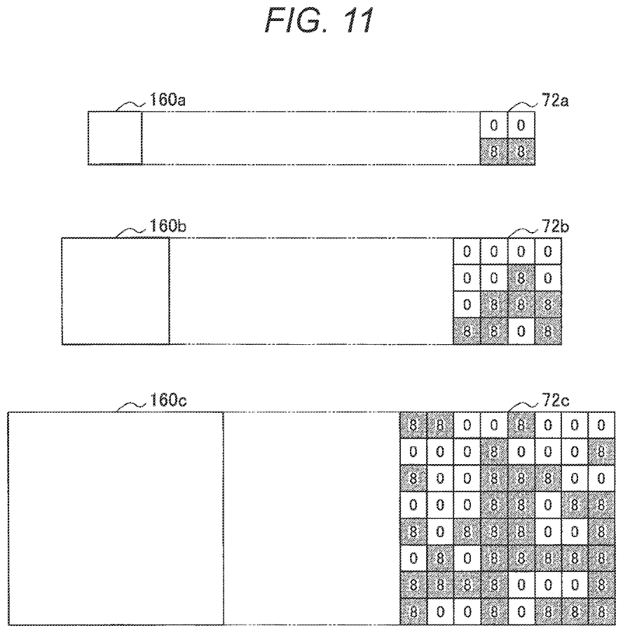

Further, in a case where there is a plurality of pieces of the first haptic information having different sizes and information densities, the data processing unit 144 may generate the second haptic information on the basis of, among the plurality of pieces of the first haptic information, a piece of the first haptic information having the information density corresponding to the size of the haptic presentation unit 160. Hereinafter, a specific description will be given with reference to FIG. 11. FIG. 11 illustrates a generation example of the second haptic information based on the size of the haptic presentation unit 160 according to the embodiment of the present disclosure.

As illustrated in an upper left diagram of FIG. 10, in a case where a haptic presentation unit 160a is small in size, the data processing unit 144 may generate the second haptic information on the basis of first haptic information 72a illustrated in an upper right diagram of FIG. 10. The first haptic information 72a has the same size as the haptic presentation unit 160a and has a low information density, and therefore the second haptic information suitable for the size of the haptic presentation unit 160a is generated.

As illustrated in a middle left diagram of FIG. 10, in a case where a haptic presentation unit 160b is medium in size, the data processing unit 144 may generate the second haptic information on the basis of first haptic information 72b illustrated in a middle right diagram of FIG. 10. The first haptic information 72b has the same size as the haptic presentation unit 160b and has a moderate information density, and therefore the second haptic information suitable for the size of the haptic presentation unit 160b is generated.

As illustrated in a lower left diagram of FIG. 10, in a case where a haptic presentation unit 160c is large in size, the data processing unit 144 may generate the second haptic information on the basis of first haptic information 72c illustrated in a lower diagram of FIG. 10. The first haptic information 72c has the same size as the haptic presentation unit 160c and has a high information density, and therefore the second haptic information suitable for the size of the haptic presentation unit 160c is generated.

With such a configuration, the user can feel an appropriate haptic sensation without being affected by the size of the haptic presentation unit 160.

(Generation Examples Based on Scale Ratio)

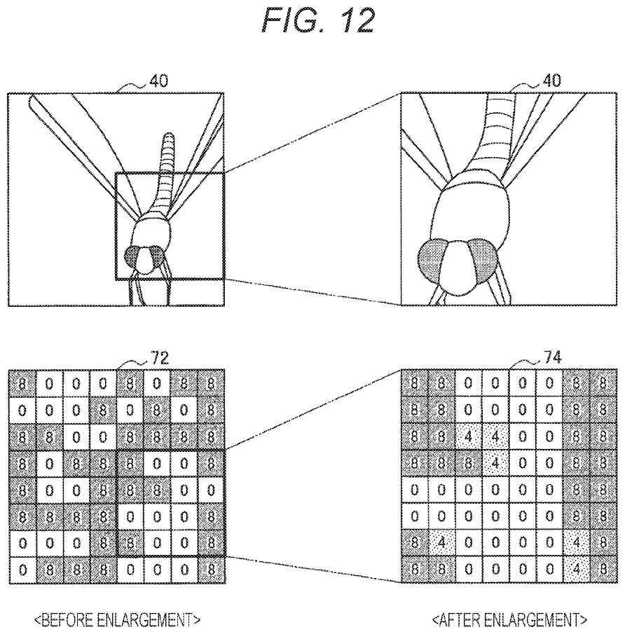

Further, the data processing unit 144 may generate the second haptic information in accordance with a scale ratio of the haptic presentation object mapped onto the haptic presentation unit 160. The scale ratio means an enlargement ratio or a reduction ratio of an image. For example, the enlargement ratio is a magnification obtained in a case where the image of the haptic presentation object displayed on the display device 40 is enlarged. Further, the reduction ratio is a magnification obtained in a case where the image of the haptic presentation object displayed on the display device 40 is reduced. Hereinafter, a specific description will be given with reference to FIGS. 12 to 14. FIGS. 12 to 14 illustrate generation examples of the second haptic information based on the scale ratio according to the embodiment of the present disclosure.

FIG. 12 illustrates an example where, in a case where there is a plurality of pieces of the first haptic information having different information densities in accordance with the scale ratio, the data processing unit 144 generates the second haptic information on the basis of, among the plurality of pieces of the first haptic information, a piece of the first haptic information having the information density corresponding to the scale ratio. For example, as illustrated in an upper diagram of FIG. 12, an image showing the haptic presentation object mapped onto the haptic presentation unit 160 is enlarged while being displayed on the display device 40. In this case, as illustrated in a lower diagram of FIG. 12, the data processing unit 144 generates second haptic information 74 by using the first haptic information having a higher information density than the first haptic information 72 that has not been enlarged.

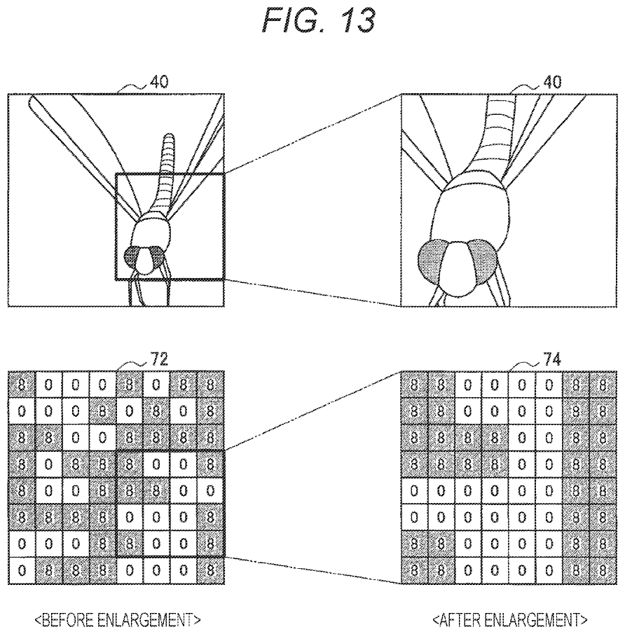

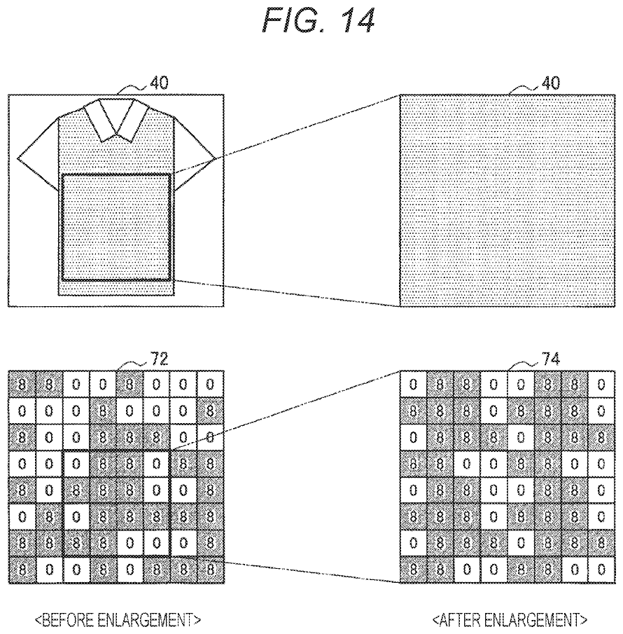

FIGS. 13 and 14 illustrate examples where, in a case where the plurality of pieces of the first haptic information does not exist, the data processing unit 144 generates the second haptic information by processing the first haptic information corresponding to the haptic presentation object mapped onto the haptic presentation unit 160 in accordance with the scale ratio.

In the example of FIG. 13, for example, in a case where an image showing the haptic presentation object is enlarged, the data processing unit 144 repeats the haptic stimulus value for each predetermined region in the first haptic information in the unit of predetermined region. Specifically, as illustrated in an upper diagram of FIG. 13, the image showing the haptic presentation object mapped onto the haptic presentation unit 160 is enlarged while being displayed on the display device 40. In this case, as illustrated in a lower diagram of FIG. 13, the data processing unit 144 repeats each haptic stimulus value region in a region to be enlarged in the first haptic information 72 that has not been enlarged twice in height and twice in width, thereby generating the second haptic information 74 having a higher information density than the first that has not been enlarged.

In the example of FIG. 14, for example, in a case where an image showing the haptic presentation object is enlarged, the data processing unit 144 repeats a pattern of the haptic stimulus values appearing in a plurality of predetermined regions in the first haptic information in the unit of the plurality of predetermined regions. Specifically, as illustrated in an upper diagram of FIG. 14, the image showing the haptic presentation object mapped onto the haptic presentation unit 160 is enlarged while being displayed on the display device 40. In this case, as illustrated in a lower diagram of FIG. 14, the data processing unit 144 repeats a region to be enlarged of four squares in height and four squares in width in the first haptic information 72 that has not been enlarged twice in height and twice in width, thereby generating the second haptic information 74 having a higher information density than the first that has not been enlarged.

Note that it is assumed that, in a case where the image of the haptic presentation object displayed on the display device 40 is enlarged or reduced, the size of the enlarged or reduced image falls within a predetermined range. In this case, the data processing unit 144 generates the second haptic information on the basis of the first haptic information corresponding to an actual size of the haptic presentation object.

Further, it is assumed that the size of the enlarged or reduced image is out of the predetermined range and is larger than the actual size of the haptic presentation object. Furthermore, in a case where there is the first haptic information having the information density corresponding to the enlarged or reduced size, the data processing unit 144 may generate the second haptic information on the basis of the first haptic information. Meanwhile, in a case where there is no first haptic information having the information density corresponding to the enlarged or reduced size, the data processing unit 144 may generate the second haptic information by repeating a pattern of predetermined regions in the first haptic information of the actual size. Note that, in a case where there is the first haptic information having a size smaller than the actual size, the data processing unit 144 may generate the second haptic information by repeating a pattern of predetermined regions in the first haptic information of the small size.

Further, it is assumed that the size of the enlarged or reduced image is out of the predetermined range and is smaller than the actual size of the haptic presentation object. Furthermore, in a case where there is the first haptic information having the information density corresponding to the enlarged or reduced size, the data processing unit 144 may generate the second haptic information on the basis of the first haptic information. Meanwhile, in a case where there is no first haptic information having the information density corresponding to the enlarged or reduced size, the data processing unit 144 may generate the second haptic information by reducing the first haptic information of the actual size.

(3-2-3. Mapping of Second Haptic Information)

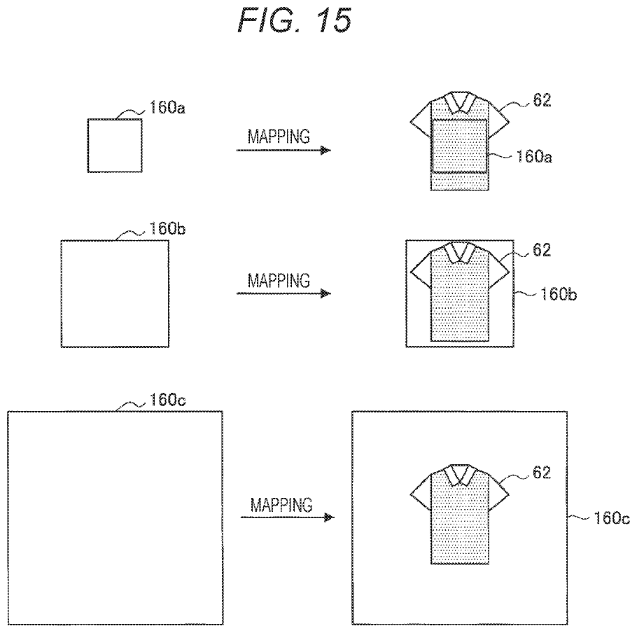

Next, mapping of the second haptic information according to the embodiment of the present disclosure will be described with reference to FIG. 15. FIG. 15 illustrates a mapping example of the second haptic information according to the embodiment of the present disclosure. Note that, in FIG. 15, for convenience of explanation, a part indicated by the second haptic information is indicated by the haptic presentation object 62 associated with the second haptic information.

The data processing unit 144 maps the generated second haptic information onto the haptic presentation unit 160. For example, the data processing unit 144 maps the second haptic information of the full-size haptic presentation object as it is onto the haptic presentation unit 160.

As an example, as illustrated in an upper diagram of FIG. 15, in a case where the full-size haptic presentation object 62 (second haptic information) is mapped as it is onto a haptic presentation unit 160a having a size smaller than the full-size haptic presentation object 62, the haptic presentation object 62 exceeds the haptic presentation unit 160a. Therefore, the second haptic information is also mapped while exceeding the haptic presentation unit 160a.

Further, as illustrated in a middle diagram of FIG. 15, in a case where the full-size haptic presentation object 62 (second haptic information) is mapped as it is onto a haptic presentation unit 160b having the same size as the full-size haptic presentation object 62, the haptic presentation object 62 is just included in the haptic presentation unit 160b. Therefore, the second haptic information is also mapped so as to be just included in the haptic presentation unit 160b.

Furthermore, as illustrated in a lower diagram of FIG. 15, in a case where the full-size haptic presentation object 62 (second haptic information) is mapped as it is onto a haptic presentation unit 160c having a size larger than the full-size haptic presentation object 62, the haptic presentation object 62 is included in the haptic presentation unit 160c with a margin. Therefore, the second haptic information is also mapped so as to be included in the haptic presentation unit 160c with a margin.

(3-2-4. Scaling of Second Haptic Information)

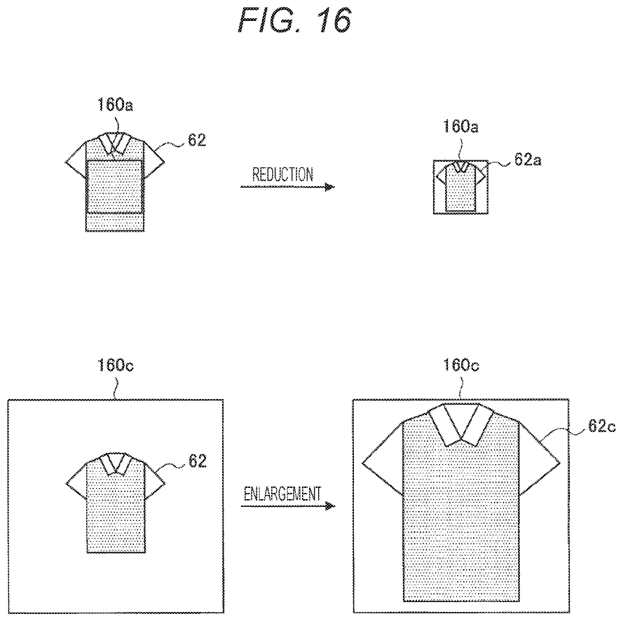

Next, scaling of the second haptic information according to the embodiment of the present disclosure will be described with reference to FIG. 16. FIG. 16 illustrates a scaling example of the second haptic information according to the embodiment of the present disclosure. For convenience of explanation, a part indicated by the second haptic information is indicated by the haptic presentation object 62 associated with the second haptic information.

In a case where the second haptic information is mapped onto the haptic presentation unit 160 but the second haptic information is not mapped in an appropriate size, the data processing unit 144 may scale the second haptic information to the appropriate size by enlarging or reducing the second haptic information and then map the second haptic information.

For example, as illustrated in an upper diagram of FIG. 16, the full-size haptic presentation object 62 (first haptic information) is mapped while exceeding the haptic presentation unit 160a. In this case, the data processing unit 144 reduces the size of the haptic presentation object 62 so that the haptic presentation object 62 is just included in the haptic presentation unit 160a, as indicated by a haptic presentation object 62a. At this time, the size of the second haptic information can be reduced while the information density remains constant. The information density of the reduced second haptic information is high and is therefore inappropriate for the size of the haptic presentation unit 160a. By using the second haptic information, an appropriate haptic stimulus may not be presented to the user.

Further, as illustrated in a lower diagram of FIG. 16, the full-size haptic presentation object 62 (first haptic information) is mapped onto the haptic presentation unit 160c with a margin. In this case, the data processing unit 144 enlarges the size of the haptic presentation object 62 so that the haptic presentation object 62 is just included in the haptic presentation unit 160c, as indicated by a haptic presentation object 62c. At this time, the size of the second haptic information is enlarged while the information density remains constant. The information density of the enlarged second haptic information is low and is therefore inappropriate for the size of the haptic presentation unit 160c. Therefore, by using the second haptic information, an appropriate haptic stimulus may not be presented to the user.

In view of this, the data processing unit 144 may regenerate the second haptic information so that the second haptic information has the information density corresponding to the scale ratio at the time of scaling. With such a configuration, the data processing unit 144 can map, onto the haptic presentation unit 160, the second haptic information having the information density suitable for the size of the scaled haptic presentation object 62 at the time of scaling the haptic presentation object 62.

(3-3. Haptic Presentation Control Unit 146)

The haptic presentation control unit 146 has a function of controlling an operation of the haptic presentation unit 160. For example, the haptic presentation control unit 146 generates a presentation signal to be presented by the haptic presentation unit 160 on the basis of the second haptic information mapped onto a position where the user touches the haptic presentation unit 160. Specifically, the haptic presentation control unit 146 reads a haptic stimulus value from the second haptic information mapped onto the position where the user touches the haptic presentation unit 160 and converts the haptic stimulus, thereby generating a presentation signal. Then, the haptic presentation control unit 146 outputs the generated presentation signal to the haptic presentation unit 160.

(4) Storage Unit 150

The storage unit 150 has a function of storing information regarding the processing in the haptic presentation device 10. In order to achieve the function, as illustrated in FIG. 3, the storage unit 150 includes a haptic information storage unit 152, a sensing information storage unit 154, and a haptic-presentation-unit-information storage unit 156.

(4-1. Haptic Information Storage Unit 152)

The haptic information storage unit 152 is a storage unit that stores haptic information. For example, the haptic information storage unit 152 stores the first haptic information acquired by the acquisition unit 142 from the server 20 via the communication unit 110 and the network 50.

(4-2. Sensing Information Storage Unit 154)

The sensing information storage unit 154 is a storage unit that stores the sensing information. For example, the sensing information storage unit 154 stores the sensing information acquired by the acquisition unit 142 from the sensor device 30 via the communication unit 110 and the sensing information acquired by the acquisition unit 142 from the sensor unit 120.

(4-3. Haptic-Presentation-Unit-Information Storage Unit 156)

The haptic-presentation-unit-information storage unit 156 is a storage unit that stores haptic presentation unit information. For example, the haptic-presentation-unit-information storage unit 156 stores the haptic presentation unit information prepared in advance. The haptic presentation unit information is, for example, information unique to the haptic presentation unit 160, such as a coefficient of restitution and a coefficient of friction.

Note that the information stored in the storage unit 150 is not limited to such examples. For example, the storage unit 150 may store programs such as various applications.

(5) Haptic Presentation Unit 160

The haptic presentation unit 160 has a function of presenting a haptic stimulus to the user. For example, the haptic presentation unit 160 presents, to the user, a haptic stimulus corresponding to a presentation signal input from the control unit 140.

The haptic presentation unit 160 can present a haptic stimulus to the user by various means. As an example, the haptic presentation unit 160 can present a haptic stimulus by an electrical stimulus, a Peltier device, a motor, air pressure, a vibrator, a speaker, a display, or the like.

The haptic presentation unit 160 presents, for example, an electrical stimulus having an intensity corresponding to a presentation signal to the user as a haptic stimulus. With such a configuration, the user can feel unevenness of a surface of the haptic presentation object as a haptic sensation via the haptic presentation unit 160.

The haptic presentation unit 160 presents, for example, heat adjusted by the Peltier device in response to a presentation signal to the user as a haptic stimulus. With such a configuration, the user can feel a temperature of the surface of the haptic presentation object as a haptic sensation via the haptic presentation unit 160.

The haptic presentation unit 160 presents, for example, reaction force generated by moving the haptic presentation unit 160 by using the motor in response to a presentation signal to the user as a haptic stimulus. With such a configuration, the user can feel a texture of the surface of the haptic presentation object as a haptic sensation via the haptic presentation unit 160.

The haptic presentation unit 160 presents, for example, vibration generated by vibrating the haptic presentation unit 160 at an arbitrary frequency by using air pressure in response to a presentation signal to the user as a haptic stimulus. Further, the haptic presentation unit 160 presents reaction force generated by moving the haptic presentation unit 160 by using air pressure in response to a presentation signal to the user as a haptic stimulus. With such a configuration, the user can feel a texture of the surface of the haptic presentation object as a haptic sensation via the haptic presentation unit 160.

The haptic presentation unit 160 presents, for example, vibration generated by vibrating the haptic presentation unit 160 at an arbitrary frequency by using the vibrator in response to a presentation signal to the user as a haptic stimulus. With such a configuration, the user can feel a texture of the surface of the haptic presentation object as a haptic sensation via the haptic presentation unit 160. Further, the haptic presentation unit 160 presents a change in a direction of motion to the user as a haptic stimulus by changing a movement pattern of mass by using the vibrator in response to a presentation signal. With such a configuration, the user can feel a change in weight of the haptic presentation object as a haptic sensation via the haptic presentation unit 160.

The haptic presentation unit 160 presents, for example, a sound of a specific frequency to the user as a haptic stimulus through the speaker in response to a presentation signal. With such a configuration, the user can feel a change in humidity as a haptic sensation via the haptic presentation unit 160. For example, in a case where a sound is output at a frequency of about 2000 Hz, the user can feel a low humidity and dry air. Meanwhile, in a case where a sound is output at a suppressed frequency, the user can feel a high humidity and wet air.

For example, the haptic presentation unit 160 presents visual feedback to the user as a haptic stimulus by using the display in response to a presentation signal. With such a configuration, the user can feel pseudo haptics via the haptic presentation unit 160.

### 3. PROCESSING EXAMPLES

Hereinabove, the configuration example according to the present embodiment has been described. Next, processing examples according to the present embodiment will be described.

<3-1. Flow of Processing in a Case where Haptic Information is not Switched>

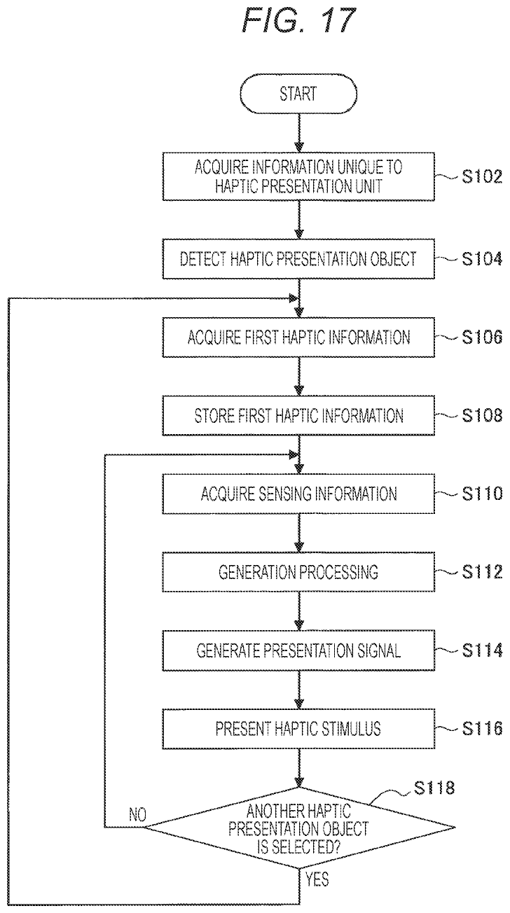

FIG. 17 is a flowchart showing a flow of processing performed in a case where haptic information according to the embodiment of the present disclosure is processed without being switched.

First, the control unit 140 of the haptic presentation device 10 acquires information unique to the haptic presentation unit 160 from the storage unit 150 (S102). Next, the control unit 140 detects the haptic presentation object selected by the user (S104). Next, the control unit 140 acquires the first haptic information corresponding to the selected haptic presentation object from the server 20 via the communication unit 110 (S106), and stores the acquired first haptic information in the storage unit 150 (S108). Next, the control unit 140 acquires the sensing information from the sensor unit 120 (S110).

After acquiring the sensing information, the control unit 140 generates the second haptic information through the generation processing (S112). After the generation processing, the control unit 140 generates a presentation signal on the basis of the generated second haptic information (S114). Then, the control unit 140 causes the haptic presentation unit 160 to present a haptic stimulus on the basis of the presentation signal (S116).

After the presentation of the haptic stimulus, in a case where another haptic presentation object is selected by the user (S118/YES), the control unit 140 repeats the processing from S106. Meanwhile, in a case where no other haptic presentation object is selected by the user (S118/NO), the control unit 140 repeats the processing from S110.

<3-2. Flow of Processing in a Case where Haptic Information is Switched>

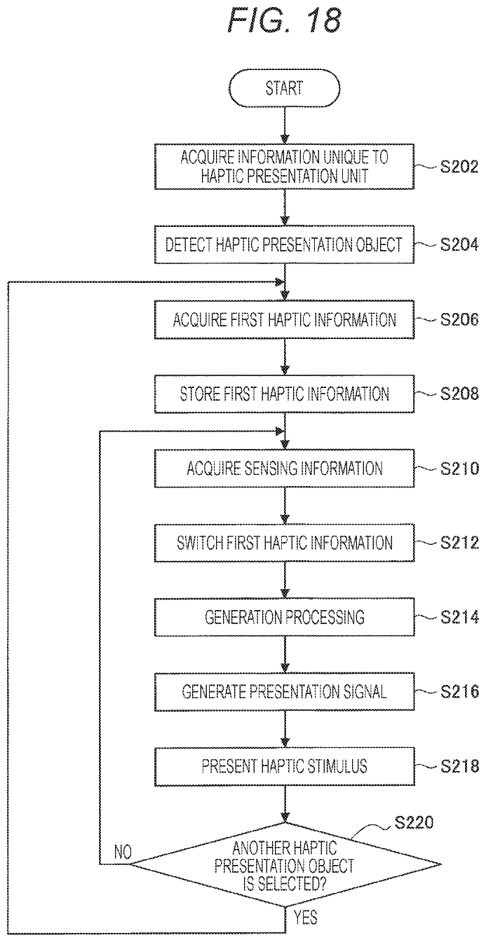

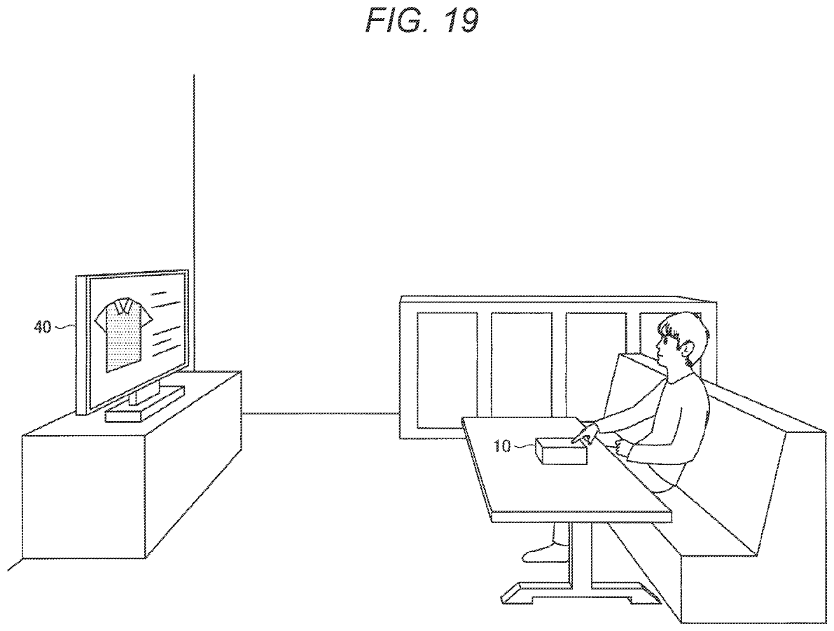

FIG. 18 is a flowchart showing a flow of processing performed in a case where haptic information according to the embodiment of the present disclosure is switched and is then processed.

First, the control unit 140 of the haptic presentation device 10 acquires information unique to the haptic presentation unit 160 from the storage unit 150 (S202). Next, the control unit 140 detects the haptic presentation object selected by the user (S204). Next, the control unit 140 acquires the first haptic information corresponding to the selected haptic presentation object from the server 20 via the communication unit 110 (S206), and stores the acquired first haptic information in the storage unit 150 (S208). Next, the control unit 140 acquires the sensing information from the sensor unit 120 (S210).

After acquiring the sensing information, the control unit 140 switches the first haptic information in accordance with the sensing information (S212). After switching the first haptic information, the control unit 140 generates the second haptic information through the generation processing (S214). After the generation processing, the control unit 140 generates a presentation signal on the basis of the generated second haptic information (S216). Then, the control unit 140 causes the haptic presentation unit 160 to present a haptic stimulus on the basis of the presentation signal (S218).

After the presentation of the haptic stimulus, in a case where another haptic presentation object is selected by the user (S220/YES), the control unit 140 repeats the processing from S206. Meanwhile, in a case where no other haptic presentation object is selected by the user (S220/NO), the control unit 140 repeats the processing from S210.

### 4. SPECIFIC EXAMPLES

Hereinabove, the configuration example according to the present embodiment has been described. Next, processing examples according to the present embodiment will be described.

### 4-1. First Specific Example

FIG. 19 illustrates a specific exemplary presentation of a haptic stimulus in a first specific example according to the embodiment of the present disclosure. FIG. 19 illustrates an example where the haptic presentation system 1000 according to the embodiment of the present disclosure is applied to online shopping.

For example, in the example of FIG. 19, a product image for online shopping is displayed on the display device 40, and haptic information corresponding to the product image is mapped onto the haptic presentation device 10. At this time, by touching the haptic presentation device 10, the user can receive a haptic stimulus corresponding to a haptic sensation that the user feels when actually touching the product displayed on the display device 40.

### 4-2. Second Specific Example

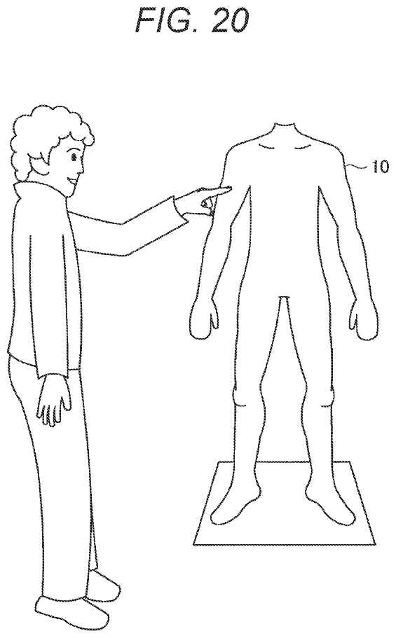

FIG. 20 illustrates a specific exemplary presentation of a haptic stimulus in a second specific example according to the embodiment of the present disclosure. FIG. 20 illustrates an example where the haptic presentation system 1000 according to the embodiment is applied to augmented reality (AR) shopping.

For example, in the example of FIG. 20, for example, a virtual object serving as virtual content such as an image is displayed while being superimposed on the haptic presentation device 10. An example of the virtual object is a product image. Haptic information corresponding to the product image has been mapped onto the haptic presentation device 10. At this time, by touching the haptic presentation device 10 on which the product image is displayed while being superimposed, the user can receive a haptic stimulus corresponding to a haptic sensation that the user feels when actually touching the product that is displayed while being superimposed.

### 5. MODIFICATION EXAMPLES

Hereinafter, modification examples according to the embodiment of the present disclosure will be described. Note that the modification examples described below may be applied to the embodiment of the present disclosure independently or in combination. Further, the modification examples may be applied instead of or in addition to the configuration described in the embodiment of the present disclosure.

### 5-1. First Modification Example

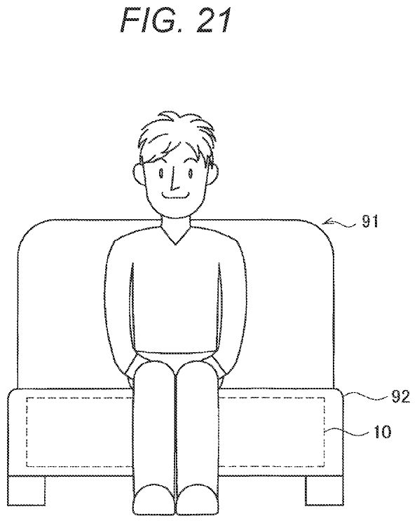

FIG. 21 illustrates an exemplary presentation of a haptic stimulus in a first modification example of the embodiment of the present disclosure. The above embodiment describes an example where a haptic stimulus is presented in a case where the user directly touches the haptic presentation device 10. For example, the haptic presentation device 10 may be included in an arbitrary object and present a haptic stimulus to the user in a case where the user indirectly touches the haptic presentation device 10.

For example, as illustrated in FIG. 21, the haptic presentation device 10 is included in a seat 92 of a sofa 91. The haptic presentation device 10 can present, for example, a haptic stimulus regarding heat to the user by using the Peltier device. At this time, when the user sits down on the seat 92 of the sofa 91, heat is presented from the haptic presentation device 10 as a haptic stimulus.

### 5-2. Second Modification Example

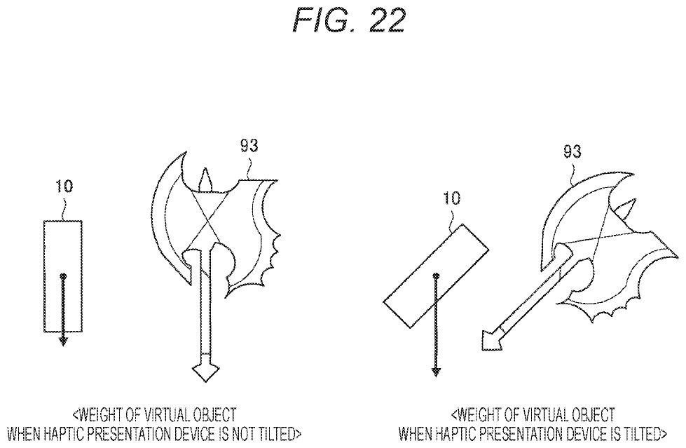

FIG. 22 illustrates an exemplary presentation of a haptic stimulus in a second modification example of the embodiment of the present disclosure. The data processing unit 144 may generate the second haptic information further on the basis of information included in the sensing information and indicating a posture of the haptic presentation device held by the user. For example, in an AR game or the like, the data processing unit 144 changes an intensity of a haptic stimulus regarding a virtual object displayed in association with the haptic presentation device 10 in accordance with the posture of the haptic presentation device 10.

In a case where the user holds the haptic presentation device 10 without tilting the haptic presentation device 10, the virtual object is displayed as illustrated in a left diagram of FIG. 22. When the user tilts the haptic presentation device 10 from this state as illustrated in a right diagram of FIG. 22, the virtual object is also displayed while being tilted. At this time, in a case where posture information indicating that the posture of the haptic presentation device 10 has changed is acquired as the sensing information, the data processing unit 144 generates the second haptic information on the basis of the posture information. For example, the data processing unit 144 may change weight feedback in accordance with the tilt of the posture by changing a mass movement pattern of a mass change vibrator in accordance with the tilt.

### 5-3. Third Modification Example

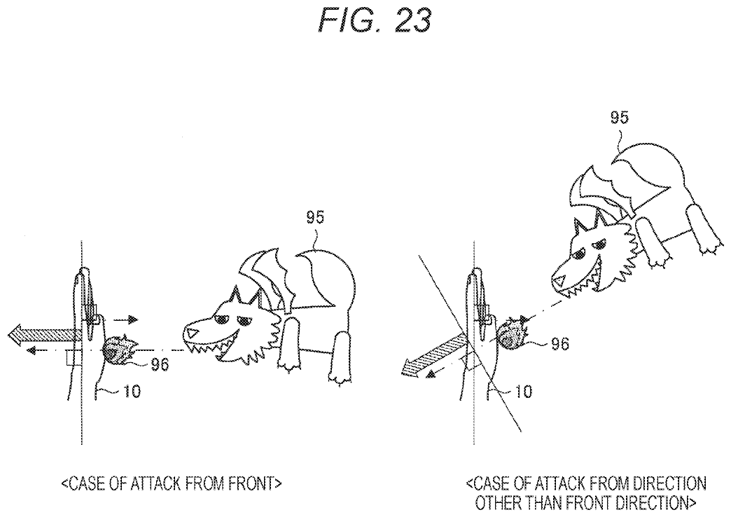

FIG. 23 illustrates an exemplary presentation of a haptic stimulus in a third modification example of the embodiment of the present disclosure. The data processing unit 144 may generate the second haptic information further on the basis of information included in the sensing information and indicating a position and posture of the user with respect to a virtual object located in a space. For example, in an AR game or the like, the data processing unit 144 changes the intensity of a haptic stimulus in accordance with the posture of the haptic presentation device 10 with respect to an energy release direction.

As illustrated in a left diagram of FIG. 23, a direction normal to the haptic presentation device 10 is parallel to a direction in which a monster 95 launches an attack 96, and the user is attacked by the monster 95 from the front. Meanwhile, as illustrated in a right diagram of FIG. 23, the direction normal to the haptic presentation device 10 is not parallel to the direction in which the monster 95 launches the attack 96, and the user is attacked by the monster 95 from a direction other than the front direction. At this time, the data processing unit 144 may make a haptic stimulus presented to the user when the user is attacked from the front as illustrated in the left diagram of FIG. 23 stronger than a haptic stimulus presented to the user in a case of the right diagram of FIG. 23.

### 6. HARDWARE CONFIGURATION EXAMPLE

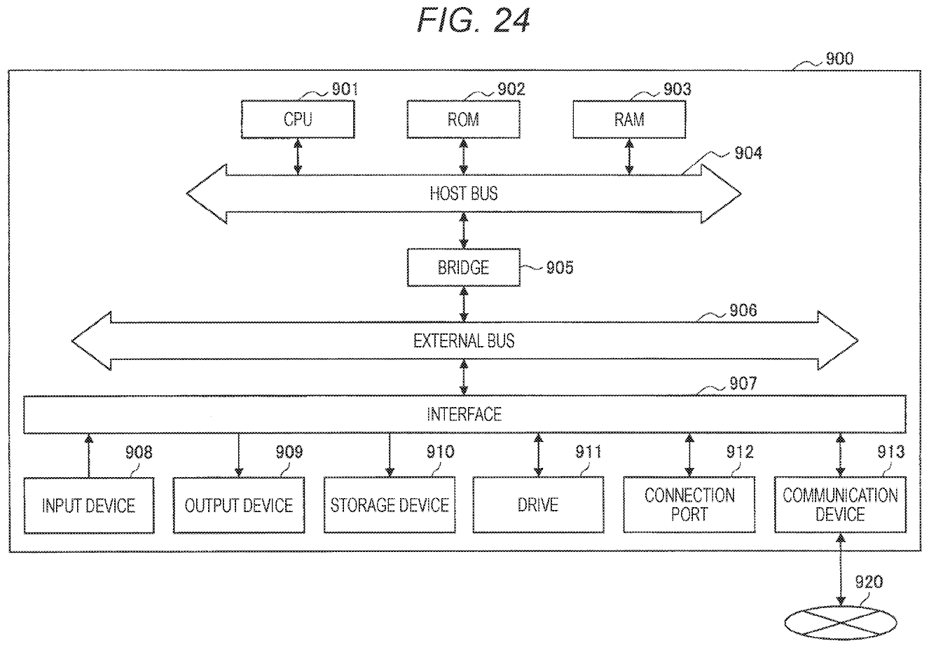

Finally, a hardware configuration example of the information processing device according to the present embodiment will be described with reference to FIG. 24. FIG. 24 is a block diagram illustrating a hardware configuration example of the information processing device according to the present embodiment. Note that an information processing device 900 of FIG. 24 can achieve, for example, the haptic presentation device 10 of FIG. 2. Information processing performed by the haptic presentation device 10 according to the present embodiment is achieved by cooperation of hardware described below and software.

As illustrated in FIG. 24, the information processing device 900 includes a central processing unit (CPU) 901, a read only memory (ROM) 902, and a random access memory (RAM) 903. Further, the information processing device 900 includes a host bus 904, a bridge 905, an external bus 906, an interface 907, an input device 908, an output device 909, a storage device 910, a drive 911, a connection port 912, and a communication device 913. Note that the hardware configuration described herein is merely an example, and some components may be omitted. Further, the hardware configuration may further include components in addition to the components described herein.

The CPU 901 functions as, for example, an arithmetic processing device or a control device, and controls a part of or the entire operation of each component on the basis of various programs recorded in the ROM 902, the RAM 903, or the storage device 910. The ROM 902 is means for storing the programs read by the CPU 901, data used for calculation, and the like. The RAM 903 temporarily or permanently stores, for example, the programs read by the CPU 901, various parameters that appropriately change when the programs are executed, and the like. Those components are mutually connected by the host bus 904 including a CPU bus or the like. The CPU 901, the ROM 902, and the RAM 903 can achieve, for example, the function of the control unit 140 described with reference to FIG. 3 in cooperation with software.

The CPU 901, the ROM 902, and the RAM 903 are mutually connected via, for example, the host bus 904 capable of transmitting data at a high speed. Meanwhile, for example, the host bus 904 is connected to the external bus 906 that transmits data at a relatively low speed via the bridge 905. Further, the external bus 906 is connected to various components via the interface 907.

The input device 908 is achieved by, for example, a device to which information is input by the user, such as a mouse, a keyboard, a touchscreen, a button, a microphone, a switch, or a lever. Further, the input device 908 may be, for example, a remote control device using infrared rays or other radio waves, or may be an external connection device that performs in response to operation of the information processing device 900, such as a mobile phone or a PDA. Furthermore, the input device 908 may include, for example, an input control circuit that generates an input signal on the basis of information input by the user by using the above input means and outputs the input signal to the CPU 901, and the like. By operating the input device 908, the user of the information processing device 900 can input various kinds of data to the information processing device 900 and instruct the information processing device 900 to perform a processing operation.

In addition, the input device 908 can include a device that detects information regarding the user. For example, the input device 908 may include various sensors such as an image sensor (e.g., a camera), a depth sensor (e.g., a stereo camera), an acceleration sensor, a gyro sensor, a geomagnetic sensor, an optical sensor, a sound sensor, a distance measurement sensor (e.g., a time of flight (ToF) sensor), and a force sensor. Further, the input device 908 may acquire information regarding a state of the information processing device 900 itself, such as a posture and moving speed of the information processing device 900, and information regarding a surrounding environment of the information processing device 900, such as luminance and noise around the information processing device 900. Further, the input device 908 may include a global navigation satellite system (GNSS) module that receives a GNSS signal (e.g., a global positioning system (GPS) signal from a GPS satellite) from a GNSS satellite to measure position information including a latitude, longitude, and altitude of the device. Furthermore, regarding the position information, the input device 908 may detect the position by Wi-Fi (registered trademark), transmission and reception with a mobile phone, a PHS, a smartphone, or the like, near field communication, or the like. The input device 908 can achieve, for example, the function of the sensor unit 120 described with reference to FIG. 3.

The output device 909 includes a device capable of visually or aurally notifying the user of acquired information. Examples of such a device encompass display devices such as a CRT display, a liquid crystal display, a plasma display, an EL display, a laser projector, an LED projector, and a lamp, sound output devices such as a speaker and headphones, and printer devices. The output device 909 outputs, for example, results of various kinds of processing performed by the information processing device 900. Specifically, the display device visually displays the results of the various kinds of processing performed by the information processing device 900 in various formats such as text, images, tables, and graphs. Meanwhile, the sound output device converts audio signals including reproduced sound data, acoustic data, and the like into analog signals and aurally outputs the analog signals. The output device 909 can achieve, for example, the function of the haptic presentation unit 160 described with reference to FIG. 3.

The storage device 910 is a data storage device provided as an example of a storage unit of the information processing device 900. The storage device 910 is achieved by, for example, a magnetic storage unit device such as an HDD, a semiconductor storage device, an optical storage device, a magneto-optical storage device, or the like. The storage device 910 may include a storage medium, a recording device that records data on the storage medium, a reading device that reads data from the storage medium, a deletion device that deletes data recorded on the storage medium, and the like. The storage device 910 stores programs and various kinds of data executed by the CPU 901, various kinds of data acquired from the outside, and the like. The storage device 910 can achieve, for example, the function of the storage unit 150 described with reference to FIG. 3.

The drive 911 is a storage medium reader/writer, and is included in or externally attached to the information processing device 900. The drive 911 reads information recorded on a removable storage medium such as an attached magnetic disk, optical disk, magneto-optical disk, or semiconductor memory, and outputs the information to the RAM 903. Further, the drive 911 can also write information into the removable storage medium.

The connection port 912 is, for example, a port for connecting an external connection device, such as a universal serial bus (USB) port, an IEEE 1394 port, a small computer system interface (SCSI), an RS-232C port, or an optical audio terminal.

The communication device 913 is a communication interface including, for example, a communication device to be connected to the network 920, and the like. The communication device 913 is, for example, a communication card for a wired or wireless local area network (LAN), long term evolution (LTE), Bluetooth (registered trademark), wireless USB (WUSB), or the like. Further, the communication device 913 may be an optical communication router, an asymmetric digital subscriber line (ADSL) router, various communication modems, or the like. For example, the communication device 913 can transmit/receive signals and the like to/from the Internet and other communication devices in accordance with, for example, a predetermined protocol such as TCP/IP. The communication device 913 can achieve, for example, the function of the communication unit 110 described with reference to FIG. 3.

Note that the network 920 is a wired or wireless transmission path for information transmitted from a device connected to the network 920. For example, the network 920 may include public networks such as the Internet, a telephone network, and a satellite communication network, various local area networks (LANs) including Ethernet (registered trademark), wide area networks (WANs), and the like. Further, the network 920 may include a dedicated network such as the Internet protocol-virtual private network (IP-VPN). The network 920 can achieve, for example, the function of the network 50 described with reference to FIG. 3.

Hereinabove, there has been described an example of the hardware configuration capable of achieving the function of the information processing device 900 according to the present embodiment. Each of the above components may be achieved by using a general-purpose member, or may be achieved by hardware specialized for the function of each component. Therefore, it is possible to appropriately change the hardware configuration to be used in accordance with a technological level at the time of implementing the present embodiment.

### 7. CONCLUSION

As described above, the information processing device according to the embodiment of the present disclosure acquires the sensing information regarding the user and the first haptic information unique to the haptic presentation object. The information processing device generates the second haptic information from the first haptic information on the basis of the acquired sensing information, the second haptic information being used in a case where the haptic presentation device presents a haptic stimulus to the user.

With such a configuration, the information processing device can generate haptic information corresponding to the sensing information regarding the user from the haptic information unique to the haptic presentation object.

Therefore, it is possible to provide a novel and improved information processing device, information processing method, and program capable of presenting a more realistic haptic stimulus.

Hereinabove, the preferred embodiment of the present disclosure has been described in detail with reference to the accompanying drawings. However, the technical scope of the present disclosure is not limited to such examples. It is obvious that a person having ordinary knowledge in the technical field of the present disclosure may find various changes or modifications within the scope of the technical idea described in the claims. As a matter of course, it is understood that those changes and modifications also belong to the technical scope of the present disclosure.

For example, each device described in the present specification may be achieved as a single device, or some or all of the devices may be achieved as separate devices. For example, the control unit 140 included in the haptic presentation device 10 of FIG. 3 may be achieved as a single device. For example, the control unit 140 may be achieved as an independent device such as a server device and be connected to the haptic presentation device 10 via a network or the like.

Further, the series of processing performed by each device described in the present specification may be achieved by software, hardware, or a combination of software and hardware. A program forming the software is stored in advance in, for example, a recording medium (non-transitory medium) provided inside or outside each device. Further, for example, each program is read into the RAM at the time of execution by a computer and is executed by a processor such as a CPU.

Further, the processing described by using the flowcharts in the present specification may not necessarily be executed in the shown order. Some processing steps may be performed in parallel. Further, additional processing steps may be adopted, and some processing steps may be omitted.

Further, the effects described in this specification are merely illustrative or exemplary and are not limited. In other words, the technology according to the present disclosure can have other effects that are apparent to those skilled in the art from the description of the present specification in addition to or in place of the above effects.

Note that the following configurations also belong to the technical scope of the present disclosure.

(1)

An information processing device including:

an acquisition unit that acquires sensing information regarding a user and first haptic information unique to a haptic presentation object; and

a data processing unit that generates second haptic information from the first haptic information on the basis of the sensing information, the second haptic information being used in a case where a haptic presentation device presents a haptic stimulus to the user.

(2)

The information processing device according to (1), in which

the sensing information includes contact information indicating a contact state between the user and the haptic presentation device, and

the data processing unit generates the second haptic information further on the basis of the contact information.

(3)

The information processing device according to (2), in which the data processing unit generates the second haptic information on the basis of a change speed at a contact position between the haptic presentation device and the user.

(4)

The information processing device according to (3), in which the data processing unit generates the second haptic information by processing the first haptic information in accordance with the change speed at the contact position.

(5)

The information processing device according to (4), in which the data processing unit generates the second haptic information in which an amount of change in haptic stimulus per unit distance is smaller as the change speed at the contact position is higher, and generates the second haptic information in which the amount of change in haptic stimulus per unit distance is larger as the change speed at the contact position is lower.

(6)

The information processing device according to any one of (2) to (5), in which the data processing unit generates the second haptic information on the basis of a contact pressure between the haptic presentation device and the user.

(7)

The information processing device according to any one of (2) to (6), in which the data processing unit generates the second haptic information on the basis of a contact area between the haptic presentation device and the user.

(8)

The information processing device according to any one of (1) to (7), in which

the sensing information includes environmental information regarding a surrounding environment of the user, and

the data processing unit generates the second haptic information further on the basis of the environmental information.

(9)

The information processing device according to any one of (1) to (8), in which the data processing unit generates the second haptic information further on the basis of information included in the sensing information and indicating a posture of the haptic presentation device held by the user.

(10)

The information processing device according to any one of (1) to (9), in which the data processing unit generates the second haptic information further on the basis of information included in the sensing information and indicating a position and posture of the user with respect to a virtual object located in a space.

(11)

The information processing device according to any one of (1) to (10), in which the data processing unit generates the second haptic information on the basis of, among a plurality of pieces of the first haptic information, a piece of the first haptic information having an information density corresponding to a size of the haptic presentation device.

(12)

The information processing device according to any one of (1) to (11), in which the data processing unit generates the second haptic information in accordance with a scale ratio of the haptic presentation object mapped onto the haptic presentation device.

(13)

The information processing device according to (12), in which the data processing unit generates the second haptic information on the basis of, among a plurality of pieces of the first haptic information, a piece of the first haptic information having an information density corresponding to the scale ratio.

(14)

The information processing device according to (12), in which the data processing unit generates the second haptic information by processing the first haptic information in accordance with the scale ratio.

(15)

The information processing device according to (14), in which

the first haptic information and the second haptic information include information indicating a haptic stimulus value for each predetermined region, and

in a case where an image showing the haptic presentation object is enlarged, the data processing unit repeats the haptic stimulus value for the each predetermined region in the first haptic information in the unit of the predetermined region.

(16)

The information processing device according to (14), in which

the first haptic information and the second haptic information include information indicating a haptic stimulus value for each predetermined region, and

in a case where an image showing the haptic presentation object is enlarged, the data processing unit repeats a pattern of haptic stimulus values appearing in a plurality of predetermined regions in the first haptic information in the unit of the plurality of predetermined regions.

(17)

The information processing device according to any one of (1) to (16), further including

a sensor unit including a sensor device, in which

the acquisition unit acquires information sensed by the sensor unit as the sensing information.

(18)

The information processing device according to any one of (1) to (17), further including

a communication unit, in which

the acquisition unit acquires information sensed by an external sensor device as the sensing information via the communication unit.

(19)

An information processing method executed by a processor, the method including:

acquiring sensing information regarding a user and first haptic information unique to a haptic presentation object; and

generating second haptic information from the first haptic information on the basis of the sensing information, the second haptic information being used in a case where a haptic presentation device presents a haptic stimulus to the user.

(20)

A program for causing a computer to function as:

an acquisition unit that acquires sensing information regarding a user and first haptic information unique to a haptic presentation object; and

a data processing unit that generates second haptic information from the first haptic information on the basis of the sensing information, the second haptic information being used in a case where a haptic presentation device presents a haptic stimulus to the user.

### REFERENCE SIGNS LIST

10 Haptic presentation device
20 Server
30 Sensor device
40 Display device
50 Network
110 Communication unit
120 Sensor unit
140 Control unit
150 Storage unit
160 Haptic presentation unit

1. An information processing device comprising:
an acquisition unit that acquires sensing information regarding a user and first haptic information unique to a haptic presentation object; and
a data processing unit that generates second haptic information from the first haptic information on a basis of the sensing information, the second haptic information being used in a case where a haptic presentation device presents a haptic stimulus to the user.

2. The information processing device according to claim 1, wherein
the sensing information includes contact information indicating a contact state between the user and the haptic presentation device, and
the data processing unit generates the second haptic information further on a basis of the contact information.

3. The information processing device according to claim 2, wherein the data processing unit generates the second haptic information on a basis of a change speed at a contact position between the haptic presentation device and the user.

4. The information processing device according to claim 3, wherein the data processing unit generates the second haptic information by processing the first haptic information in accordance with the change speed at the contact position.

5. The information processing device according to claim 4, wherein the data processing unit generates the second haptic information in which an amount of change in haptic stimulus per unit distance is smaller as the change speed at the contact position is higher, and generates the second haptic information in which the amount of change in haptic stimulus per unit distance is larger as the change speed at the contact position is lower.

6. The information processing device according to claim 2, wherein the data processing unit generates the second haptic information on a basis of a contact pressure between the haptic presentation device and the user.

7. The information processing device according to claim 2, wherein the data processing unit generates the second haptic information on a basis of a contact area between the haptic presentation device and the user.

8. The information processing device according to claim 1, wherein
the sensing information includes environmental information regarding a surrounding environment of the user, and
the data processing unit generates the second haptic information further on a basis of the environmental information.

9. The information processing device according to claim 1, wherein the data processing unit generates the second haptic information further on a basis of information included in the sensing information and indicating a posture of the haptic presentation device held by the user.

10. The information processing device according to claim 1, wherein the data processing unit generates the second haptic information further on a basis of information included in the sensing information and indicating a position and posture of the user with respect to a virtual object located in a space.

11. The information processing device according to claim 1, wherein the data processing unit generates the second haptic information on a basis of, among a plurality of pieces of the first haptic information, a piece of the first haptic information having an information density corresponding to a size of the haptic presentation device.

12. The information processing device according to claim 1, wherein the data processing unit generates the second haptic information in accordance with a scale ratio of the haptic presentation object mapped onto the haptic presentation device.

13. The information processing device according to claim 12, wherein the data processing unit generates the second haptic information on a basis of, among a plurality of pieces of the first haptic information, a piece of the first haptic information having an information density corresponding to the scale ratio.

14. The information processing device according to claim 12, wherein the data processing unit generates the second haptic information by processing the first haptic information in accordance with the scale ratio.

15. The information processing device according to claim 14, wherein
the first haptic information and the second haptic information include information indicating a haptic stimulus value for each predetermined region, and
in a case where an image showing the haptic presentation object is enlarged, the data processing unit repeats the haptic stimulus value for the each predetermined region in the first haptic information in the unit of the predetermined region.

16. The information processing device according to claim 14, wherein
the first haptic information and the second haptic information include information indicating a haptic stimulus value for each predetermined region, and
in a case where an image showing the haptic presentation object is enlarged, the data processing unit repeats a pattern of haptic stimulus values appearing in a plurality of predetermined regions in the first haptic information in the unit of the plurality of predetermined regions.

17. The information processing device according to claim 1, further comprising
a sensor unit including a sensor device, wherein
the acquisition unit acquires information sensed by the sensor unit as the sensing information.

18. The information processing device according to claim 1, further comprising
a communication unit, wherein
the acquisition unit acquires information sensed by an external sensor device as the sensing information via the communication unit.

19. An information processing method executed by a processor, the method comprising:
acquiring sensing information regarding a user and first haptic information unique to a haptic presentation object; and
generating second haptic information from the first haptic information on a basis of the sensing information, the second haptic information being used in a case where a haptic presentation device presents a haptic stimulus to the user.

20. A program for causing a computer to function as:
an acquisition unit that acquires sensing information regarding a user and first haptic information unique to a haptic presentation object; and
a data processing unit that generates second haptic information from the first haptic information on a basis of the sensing information, the second haptic information being used in a case where a haptic presentation device presents a haptic stimulus to the user.
